(19) United States
(12) Patent Application Publication
(10) Pub. No.: US 2021/0064453 A1
(43) Pub. Date: Mar. 4, 2021

(54) AUTOMATED APPLICATION PROGRAMMING INTERFACE (API) SPECIFICATION CONSTRUCTION

(71) Applicant: FUJITSU LIMITED, Kawasaki-shi (JP)

(72) Inventors: Mehdi BAHRAMI, Santa Clara, CA (US); Wei-Peng CHEN, Fremont, CA (US)

(73) Assignee: FUJITSU LIMITED, Kawasaki-shi (JP)

(21) Appl. No.: 16/559,377

(22) Filed: Sep. 3, 2019

(51) Int. Cl. G06F 9/54; G06F 16/958

(52) U.S. Cl. CPC G06F 9/547; G06F 16/986

(57) ABSTRACT

A method may include accessing, by a processor, a first server associated with a first provider of at least one application programming interface (API); automatically selecting, by the processor, the at least one API provided by the first provider; constructing a list of features associated with the selected at least one API; parsing, by the processor, a first HyperText Transfer Protocol (HTML) page associated with the selected at least one API; automatically simulating, by the processor, at least one user interaction with the first HTML page; extracting, by the processor, API object information based on: a) constructing the list of features, b) parsing the first HTML page, and c) automatically simulating the at least one user interaction with the first HTML page; and constructing, by the processor, a machine-readable API specification based on the extracted API object information.

### FIELD

The embodiments discussed in the present disclosure are related to automated application programming interface (API) specification construction.

### BACKGROUND

Software applications may be built using one or more APIs. An API may include a set of routines, protocols, and tools that specify how software components interact and for building software applications. An API may expose functions or data of a software application that enables other applications to use the API's resources without concern for implementation of the functions or data. In some cases, an API provider may offer a semi-structured platform for a programmer to discover and interact with available APIs. In some embodiments, the API platform may offer a “try-out” page in which a plurality of APIs may be accessed through a web interface containing at least one HyperText Markup Language (HTML) page. In some cases, however, the API platform may not provide a machine-readable API specification or may provide an interactive API specification that may require interactive actions.

The subject matter claimed in the present disclosure is not limited to embodiments that operate only in those environments described above. Rather, this background is provided to illustrate one example technology area where some embodiments described in the present disclosure may be practiced.

### SUMMARY

One or more embodiments of the present disclosure may include a method that includes accessing, by a processor, a first server associated with a first provider of at least one application programming interface (API); automatically selecting, by the processor, the at least one API provided by the first provider; constructing a list of features associated with the selected at least one API; parsing, by the processor, a first HyperText Transfer Protocol (HTML) page associated with the selected at least one API; automatically simulating, by the processor, at least one user interaction with the first HTML page; extracting, by the processor, API object information based on: a) constructing the list of features, b) parsing the first HTML page, and c) automatically simulating the at least one user interaction with the first HTML page; and constructing, by the processor, a machine-readable API specification based on the extracted API object information.

The object and advantages of the embodiments will be realized and achieved at least by the elements, features, and combinations particularly pointed out in the claims.

It is to be understood that both the foregoing general description and the following detailed description are merely examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment related to automated API specification construction;

FIG. 2 illustrates a flowchart of an example method of automated API specification construction;

FIG. 3 illustrates a flowchart of an example method of automated API specification construction;

FIG. 4 illustrates a flowchart of an example method of automated API specification construction; and

FIG. 5 illustrates an example computing system related to automated API specification construction.

### DESCRIPTION OF EMBODIMENTS

The present disclosure relates to the use of a computing system to automatically construct an API specification using semi-structure information extraction. As used in this disclosure, the term API specification may refer to computer-readable instructions for calling and/or implementing an API resource and may include routines, data structures, object classes, variable, and/or remote calls. As used in this disclosure, the term API resource may refer to the actual API that is being used, called, implemented, etc. In some circumstances, an API document may include snippets or other portions of example programming code with explanation regarding the programming code. As used in this disclosure, the term API document may refer to documentation, web pages, or other materials that describe an API using plain language, such as a website or other hypertext markup language (HTML) document, a user's guide or reference, an owner's manual, a readme.txt file or a Portable Document Format (PDF) file, or other similar or comparable document that describes an API resource. Thus, an API document may describe an API resource, and the API specification may include computer-readable code that implements, calls, or otherwise invokes or utilizes the API resource.

In some embodiments, an API may publish its own servers and/or data through different protocols having different types of data with different attributes. Many APIs do not have formal definitions and many APIs have human readable descriptions which are described as an HTML file. Further, API functionalities and their documentation can be updated periodically.

Current technology, such as that described in U.S. application Ser. No. 15/374,798 (“API LEARNING”), may be employed to extract information from API documents; however, in some cases, current technology may not work interactively with HTML pages provided by an API platform. For example, an HTML page provided by an API provider, and associated with at least one API, may include interactive actions such as logging onto the provider's API platform, clicking on links to obtain information, selecting options from lists presented on the HTML page, filling in forms, scrolling to identify a list of available APIs, etc. Thus, the embodiments described in this disclosure detail a method and system for using an existing provider's API platform to automatically and interactively extract information from at least one of multiple potential HTML pages in order to access both private and public API information. In some embodiments, automatically and interactively extracting information from HTML pages may include the computer system programmatically simulating a user's manual actions within a webpage (e.g., clicking on a link).

By enabling automatic interaction with HTML pages associated with at least one API, the method may produce, for example, an OpenAPI Specification (OAS) file. The OpenAPI Specification may define a standard, language-agnostic interface to APIs which allows both humans and computers to discover and understand the capabilities of the service without access to source code, documentation, or through network traffic inspection. An OpenAPI definition can be used by document generation tools to display the API, code generation tools to generate servers and clients in various programming language, testing tools, and other cases. In some embodiments, the OAS file may be produced in a machine-readable format such as YAML Ain't Markup Language (YAML) or JavaScript Object Notation (JSON).

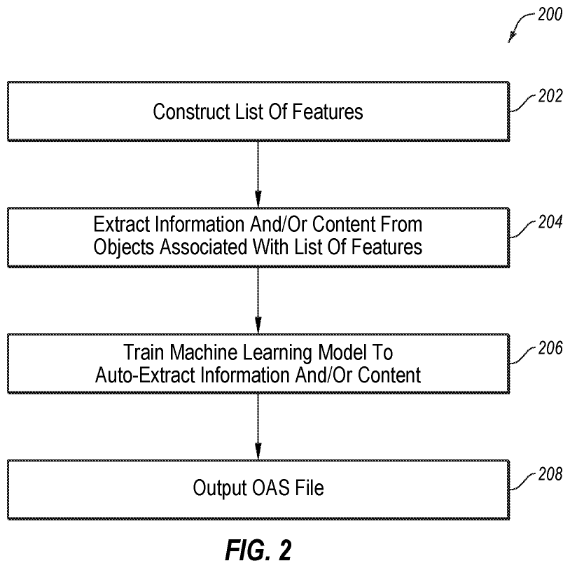

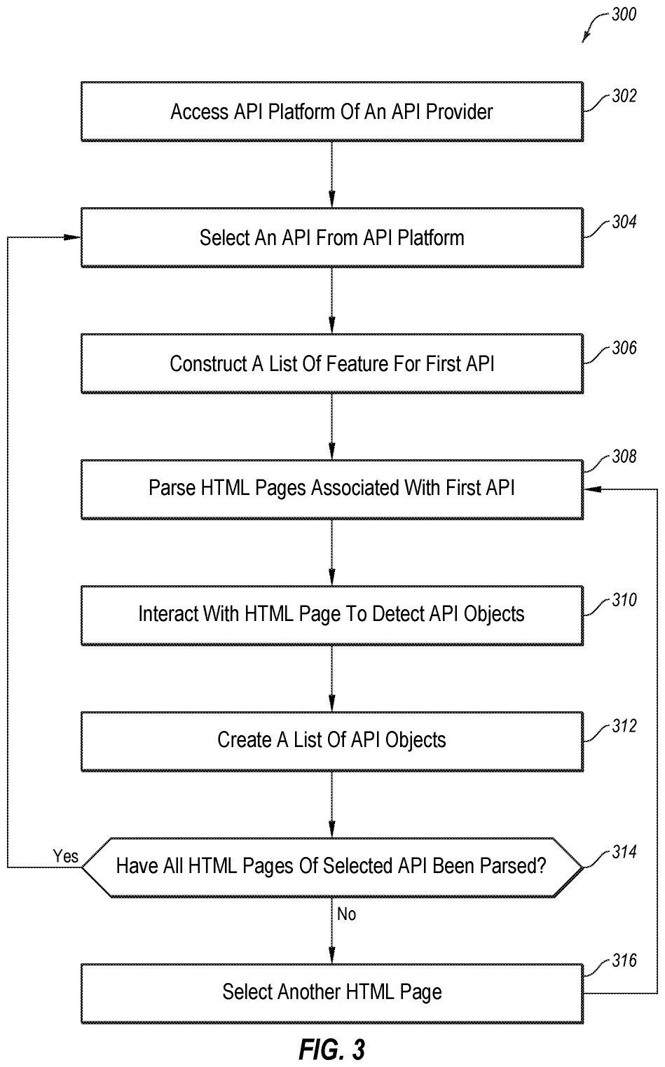

In some embodiments, in constructing an OAS file, a computing device may automatically interact with an HTML page associated with an API to extract functions and tables of attributes from API documents. An API features list may be created based on interaction with the HTML page, and with reference to the API features list, information and/or content may be extracted from the HTML page in order to construct a list of API objects. In some embodiments, the list of API objects may be objects associated with Open API specifications (e.g., OAS objects). Construction of the API features list may be described in more detail with respect to FIG. 2. Extraction of content and/or information and construction of the API objects list may be described in more detail with respect to FIG. 3.

Embodiments of the present disclosure are explained with reference to the accompanying drawings.

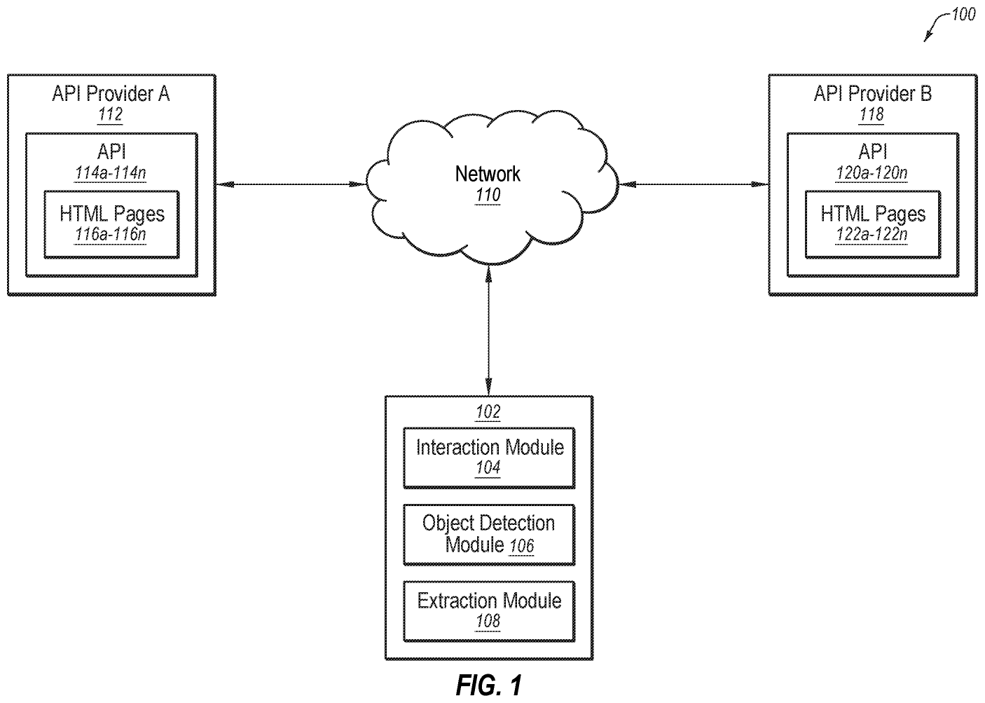

FIG. 1 illustrates an example environment 100 related to automated API specification construction, in accordance with one or more embodiments of the present disclosure. The environment 100 may include a computing system 102 configured to automatically construct an API specification using semi-structure information extraction. In some embodiments, the computing system 102 may include an interaction module 104, an object detection module 106, and/or an extraction module 108.

In addition, the environment 100 may further include a server 112 associated with API Provider A. The server 112 may host multiple HTML pages 116a-116n associated with at least one API of multiple accessible APIs 114a-114n. Additionally or alternatively, the environment 100 may further include a server 118 associated with API Provider B. Server 118 may host multiple HTML pages 122a-122n associated with at least one API of multiple accessible APIs 120a-120n. In some embodiments, the server 112 and the server 118 may be the same computing system, different computing systems, or any combination thereof, hosting any number of HTML pages, and/or storing any combination of API documents and/or API specifications.

In some embodiments, the computing system 102 may be configured to analyze any of the HTML pages 116a-116n and/or 122a-122n associated with at least one of the APIs 114a-114n, and/or 120a-120n, respectively. Any of the HTML pages may be consider or be part of an API document that includes a description of how a given API resource described in the API document works, what functionality the given API resource provides, the purposes of the given API resource (e.g., goals, inputs, outputs, etc.), how a software application may interact with the given API resource, examples in different programming languages of how to interact with the given API resource, descriptions of API parameters (e.g., inputs) and responses (e.g., outputs), etc. In some embodiments, the API document and/or HTML page may include interactive objects (e.g., links, forms, buttons, actions, etc.), plain text sentences, tables of information, code, metadata, etc.

For brevity, the remaining description will refer to the HTML pages 116a-116n associated with the example API 114a, where the example API 114a is provided by API Provider A and hosted on the server 112. It should be understood that the methods and systems described in this disclosure may apply to any API document and/or HTML page associated with any number of APIs provided by any number of API providers.

In some embodiments, an API provider may be any entity that provides a user data and/or capabilities presented in an API. Example API providers may include Amazon Web Services, Google APIs Explorer, MasterCard APIs, PayPal APIs, etc. In some embodiments, each API provider that provides HTML pages associated with available APIs may be associated with a domain name or IP address of a host that hosts the HTML pages.

In some embodiments, in combination with the automatic HTML page interactions described in this disclosure, the computing system 102 may perform a process to extract information from the example HTML pages 116-116n. The output of such an extraction process may include one or more functions, a description of each of the one or more functions and/or one or more tables that include attributes.

The tables extracted from the example HTML pages 116a-116n may include one or more attributes associated with a given API resource of any of the example HTML pages 116a-116n. In some embodiments, an extracted table may be associated with a given type. For example, a table may include input parameters of a given API resource, input data for a given API resource, output data for a given API resource, output result (e.g., the format of the output) for a given API resource, error codes of a given API resource, or any other attributes associated with a given API resource. In some embodiments, one or more of the extracted tables may provide information regarding one or more types of inputs. For example, an extracted table may provide information regarding the input parameters, such as whether they are required, character limits, etc.

In some embodiments, the computing system 102 may analyze the HTML pages 116a-116n and/or 122a-122n by communicating over the network 110. Additionally or alternatively, the computing system 102 may provide the HTML pages to another computing system while communicating over the network 110.

The network 110 may be implemented as a wired or wireless network, and/or may have numerous different configurations or combinations thereof. Furthermore, the network 110 may include a local area network (LAN), a wide area network (WAN) (e.g., the Internet), or other interconnected data paths across which multiple devices and/or entities may communicate. In some embodiments, the network 110 may include a peer-to-peer network. The network 110 may also be coupled to or may include portions of a telecommunications network for sending data in a variety of different communication protocols. In some embodiments, the network 110 may include Bluetooth® communication networks or cellular communication networks for sending and receiving communications and/or data including via short message service (SMS), multimedia messaging service (MMS), hypertext transfer protocol (HTTP), direct data connection, wireless application protocol (WAP), e-mail, or other approaches. The network 110 may also include a mobile data network that may include third-generation (3G), fourth-generation (4G), long-term evolution (LTE), long-term evolution advanced (LTE-A), Voice-over-LTE (VoLTE) or any other mobile data network or combination of mobile data networks.

Modifications, additions, or omissions may be made to the environment 100 without departing from the scope of the present disclosure. For example, in some embodiments, the environment 100 may be a system. As another example, the environment 100 may include any number of API documents, API specifications, HTML pages, etc. from any number of computing systems.

For each of the methods illustrated in FIGS. 2-4, the methods may be performed by any suitable system, apparatus, or device. For example, the computing system 102 of FIG. 1, or other systems or devices may perform one or more of the operations associated with the methods. Although illustrated with discrete blocks, the steps and operations associated with one or more of the blocks of the methods may be divided into additional blocks, combined into fewer blocks, or eliminated, depending on the desired implementation.

Additionally, for each of the methods illustrated in FIGS. 2-4, modifications, additions, or omissions may be made to the methods without departing from the scope of the present disclosure. For example, the operations of the methods illustrated in FIGS. 2-4 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 2 illustrates a flowchart of an example method 200 of construction an API feature list, in accordance with one or more embodiments of the present disclosure. In some embodiments, the API feature list may be constructed from API documentation associated with an API provided by the API provider. The API features may include specific information related to each of the API providers and may detail which API objects may be relevant to each parameter of an API. For example, the API feature list may include elements of the API that include data that may define, describe, or otherwise be used to assist someone to construct code that may call or interact with the API.

At block 202, the computing system 102 may construct the API feature list obtained from the HTML pages associated with each API provider (e.g., example HTML pages 116a-116n associated with the example APIs 144a-144n provided by API Provider A). Thus, the computing system 102 may interact with each of the example HTML pages 116a-116n in order to construct a list of API features that include data that describes the API that may be extracted from the HTML pages.

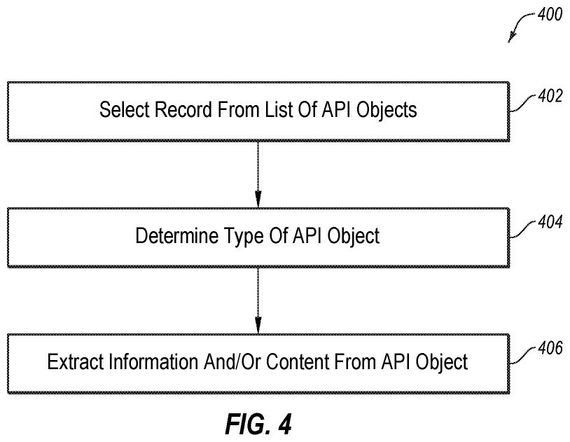

At block 204, the computing system 102 may extract the data from the constructed API feature list. The data may include information regarding the API and/or content within the API. For example, the information may include information regarding the coding construction of the API and context may include information provided by or within the API that is not related to the construction of the API. For example, the computing system 102 may extract information such as an API name, an endpoint, an HTTP verb, API parameters, Cascading Style Sheet (CCS) name, a CCS identification (ID), an HTML tag name, an HTML tag ID, text information, tag object information, user credentials, etc. Extraction of information and/or content is described with more detail with reference to FIG. 4.

At block 206, the computing system 102 may train a machine learning model to create a method of auto-extracting the data that make up the API feature list. In some embodiments, the machine learning model may receive the extracted content (whether it has been extracted automatically or through manual interaction). The content may be fed into a Bi-direction long short-term memory (Bi-LSTM) model, for example, which may encode the extracted content. The model may operate to understand the variety of HTML tags and the parse tree of the DOM which corresponds to each API object. For example, the machine learning model may learn that the HR tags in “<HR>Verb Endpoint</HR> corresponds to “Paths->Endpoint->verb in the OAS file.

At block 208, the machine learning model may apply the method to different APIs provided by the same API provider, including applying the machine learning model to all of the HTML pages associated with the selected API provider. In some embodiments, the machine learning model may be applied to various APIs provided by a different API provider.

In some embodiments, the machine learning model may include an API feature encoder (e.g., BiLSTM) model, a dense layer, and an API Feature decoder. The API feature decoder may then feed into an API object encoder (e.g., BiLSTM) model, another dense layer, and an object decoder, resulting in a trained model.

At block 208, the computing system 102 may output an OAS file for the selected API provider. In some embodiments, the computing system 102 may automatically create the OAS file from the data extracted at block 204 and/or block 206. The OAS file may be constructed in JSON or YAML, and may include general information about the API, available paths, available operations, input and output for each operation performed by the API. In short, the OAS file may include the information for building code that may call or otherwise interact with the API.

FIG. 3 illustrates a flowchart of an example method 300 of constructing a list of API features, in accordance with one or more embodiments of the present disclosure. In some embodiments, the method 300 may provide an example of and/or greater detail of block 202 of FIG. 2.

At block 302, the interaction module 104 of the computing system 102 may access an API platform of an API provider (e.g., API Provider A). For example, an example API provider may be Google®, and the API platform may be Google's APIs Explorer. For purposes of clarity and brevity, the discussion of FIG. 3 will be made with reference to Google's APIs Explorer platform; however, it is to be understood that the methods and systems described in this disclosure may be applied to any API provider and/or platform. In some embodiments, the API platform may provide an interactive list of APIs provided by the API provider.

At block 304, the interaction module 104 may automatically and programmatically select one of the APIs provided by API provider on the provider's API platform. At block 306, the interaction module 104 may construct an API feature list, which may be used again for various APIs provided by the same API provider. In one example embodiment, an AI feature may be HTML tags that correspond to each segment of an API (e.g., the API description may use HTML tags corresponding to “<H1><H2 id=‘title’>.”) By constructing the API feature list, a machine learning algorithm may learn about different features of APIs from different API providers.

In some embodiments, the API feature list associated with the API may include data about the API such as API objects, HTML object information, API provider information, Document Object Model (DOM) objects, HTML tags, CCS style objects, user credentials, possible user actions, etc. In some embodiments, the API object may include a list of target API objects to be extracted from the API provider. API objects may include fields such as openapi, info, servers, paths, components, security, tags, externalDocs, title, description, termsOfService, contact, license, version, name, url, email, description, variables, enum, default, schemas, responses, parameters, examples, requestBodies, headers, securitySchemes, links, callbacks, etc.

In some embodiments, the DOM object may represent objects used to represent and manipulate an API, behaviors and attributes, and relationships and collaborations of the API may include a unique address of a DOM path used to access an API object. Additionally or alternatively, the DOM object may include a class name of the API object, a HTML tag name, an HTML tag ID, etc.

In some embodiments, user credentials may include data related to required information for accessing restricted HTML pages associated with the API provider including a user name, password, required protocols, etc.

In some embodiments, user actions may include detailed information regarding an action that a user may take on a selected object such as logging in, scrolling, clicking on links or on buttons, dragging-and-dropping etc.

An example of constructing an API feature list is described with reference to Google's APIs Explorer. In some embodiments, the computing system 102 (e.g., the interaction module 104 and/or the object detection module 106) may determine an HTTP method (e.g., “verb”) and an endpoint which may define a base URL and authentication credentials to use when making HTTP requests. An endpoint may refer to a base IP address and port, a hostname of the target system, and/or paths. Example HTTP methods or verbs may include POST, GET, PUT, DETELE, etc. An example endpoint may be “abusiveexperiencerepot.sites.get” from accessing a list of available APIs on Google's APIs Explorer.

At block 308, the interaction module 104 may automatically and programmatically parse a first example HTML page associated with the first selected API in order to detect API features (e.g., as may be retrieved from the list of features from block 204 of FIG. 2) and interactive elements present within the first example HTML page. In some embodiments, interactive elements may include clickable links, fillable forms, scrolling actions, buttons, checkboxes, etc. In some embodiments, the API features may be determined from API documentation and may include specific information for each API provider, including objects relevant to a parameter of the API such as a CSS name, CSS ID, HTML tag name, HTML tag ID, text information, HTML tag object information, user credentials for accessing private information, etc.

In some embodiments, parsing may include crawling (e.g., interacting with and following links) and data scraping.

In some embodiments, the interaction module 104 may parse the first example HTML page by processing a URL and returning the contents of the source code, including HTML tags and DOM objects. In some embodiments, the interaction module 104 may utilize a Selenium browser to apply different interaction rules in order to interact with different web pages, as the Selenium browser enables the selected API platform to access, read, and apply different actions as needed.

While making reference to the previously constructed API Feature list, the interaction module 104 may automatically parse the first example HTML page to extract API features from the first HTML page. At a subsequent time, the interaction module 104 may automatically parse a different, but associated, HTML page in order to extract API features from the different HTML page.

An example of the HTML code from which the API features may be extracted may be as follows:

<td class> = “NYYWNC-h-c”>

<span class = “gwt-InlineLabel”>
abusiveexperiencereport.site.get</span> == $0 </td>

In some embodiments, a DOM path and DOM object for the HTTP method and the endpoint may be obtained by the computing system 102 from the HTML code and placed into a table, such as shown in example Table 1 below:

TABLE 1

| | | | | User | |
|---|---|---|---|---|---|
| API | API | DOM Object | | Creden- | User |
| Object | Provider | td.class | span.class | tial's | Actions |
| HTTP | Provider | NYYWNC- | Gwt- | NA | click |
| Verb | A | h-c | InlineLabel | NA | |

| | |
|---|---|
| Endpoint | Provider |
| | A |

Thus, a list of features may be constructed as shown in the example Table 1. Example Table 1 contains information from a single selected API from a single example API provider. A single API provider, Provider A, such as Google®, however, may make available APIs following only one set of rules, and thus the list of features constructed for the above example of Google's Abusive Experience Report API may be applied to another API provided by Google® on Google's APIs Explorer, such as the Google App Engine API.

At block 310, the interaction module 104 may automatically interact with the HTML page(s) associated with the selected API to interactive elements and/or API objects associated with the list of features from FIG. 2. For example, if there is an interactive element that requires an action, the interaction module 104 may apply the determined interaction. The interactions may include logging in, clicking on a link or a button, selecting an object by way of an option button or a check box, filling in a form, scrolling through a page, etc.

In one example, the HTML page may include links or buttons that are intended to be clicked on in order to process a next step. Thus, the interaction module 104 may automatically and programmatically click on a link, select an option button to access more information about the selected API, click on a submit button, etc.

In one example, the HTML page may include more information that is presented upon a single look at the page; for example, more information may be obtained by scrolling to another portion of the presented HTML. Thus, the interaction module 104 may automatically and programmatically scroll to different portions of each example HTML page in order to access more information provided on the API platform.

In one example, the HTML page may include DOM object information for detecting a login page (e.g., the computing system may detect when a user has been logged off of a webpage, and when the webpage requires a user to login again), a login uniform resource locator (URL), a user name, a password, etc. Thus, the interaction module 104 may have access to or have determined user credentials, and may provide the user credentials to a login form and interact with a submit button in order to log onto a different HTML page. For example, an API provided by the API provider may be associated with multiple HTML pages; however, at least one of the pages may require sign-in credentials in order for a user to access one of the HTML pages. Thus, the interaction module 104 may automatically login at a login prompt to access another associated HTML page.

In some embodiments, the API objects may be detected through interaction with DOM objects. DOM is a cross-platform and language independent interface which considers an eXtensible Markup Language (XML) or HTML document as a tree structure, where each node is an object representing part of the document. Each branch of the tree ends in a node, and each node contains an object.

In some embodiments, the extraction module 108 may thus extract information from the detected API objects. Extracted information may include a CSS style class name of a selected object, the path from the HTML root to the selected object (i.e.,)(Path), the HTML tag name from the selected object, the tag ID of the selected object, etc.

Through interaction with the DOM objects on the HTML page, a list of API objects may be created. More specifically, at block 312, and by interacting with the DOM objects detected on the HTML page, the object detection module 106 may detect many API objects and may subsequently create a list of API objects. In some embodiments, the list of API objects may be DOM objects associated with an API. An example of HTML tags is provided below:

<TABLE Style=CSS_Y” ID=“Table_X”> <ROWS> <TR>

<TD>Shady Grove</TD> <TD>Aeolian</TD> </TR> <TR> <TD>Over
the River, Charlie</TD> <TD>Dorian</TD> </TR> </ROWS>
</TABLE>

From the example list of HTML tags, an example list of API objects may extracted and shown in example Table 2 below:

TABLE 2
DOM Object

| CSS Class Name | HTML Tag Name | Tag ID | XPath |
|---|---|---|---|
| CSS_Y | Table | TableX | Table |

A list of API objects may be created for each API provided by the API provider. At block 314, the computing system 102 may determine if each of the HTML pages associated with the selected API have been parsed and the information and/or content has been extracted. If each of the HTML pages has been parsed, then the computing system 102 returns to block 304 and repeats the process with a different API. At block 316, the computing system 102 may thus repeat the process described above until all of the HTML pages associated with each of the APIs accessible on the API platform are parsed and the information and/or content is extracted.

If the computing system 102 determines that all of the HTML pages associated with the selected API have not been parsed, however, then the computing system 102 returns to block 308 and repeats the process until each of the associated HTML pages have been processed. Once all of the APIs accessible on an API platform of a first API provider are processed, the computing system 102 will move to a second API provider, such as by accessing the server 118, where the server 118 hosts an API platform associated with API Provider B.

Subsequent to constructing the list of possible API objects associated with each API provided by the selected API provider, the computing system 102 may extract information and/or content from the source pages associated with each API. Thus, the computing system 102 may process each of the HTML tags identified previously and extract information and/or content according to the detected API objects which make up the list of API objects constructed in block 314 of FIG. 3. In some embodiments, the extracted information and/or content may include OAS required objects, sample codes in different programming languages, GitHub sources, contents, tables, interactive pages, responses of interactive pages, etc. Extracting information and/or content from the API objects is described in more detail with reference to FIG. 4.

FIG. 4 illustrates a flowchart of an example method 400 of extracting information and/or content from the HTML page associated with each APIs described with reference to FIG. 3. At block 402, the extraction module 108 may select a record from the list of API objects constructed in block 314 of FIG. 3. At block 404, the extraction module 108 may determine what type of API object is indicated in the selected record from the list of API objects; for example, the type of API object may include metadata, a table of information, code, a “try out”, a GitHub source, etc.

In some embodiments, the metadata may correspond to metadata information associated with the API associated with the selected record from the list of objects. The metadata may include the API host name, API provider name, API name or title, API version, API contact information, API update date, API provider social networks, API description, terms of service, API license, API support information, API document page, API URL, API scheme, API email, etc.

In some embodiments, the table may be an HTML table that contains, for example, API endpoints, API parameters of an endpoint, API responses of an endpoint, API security information, etc. An example of HTML table information is shown below:

TABLE 3

| | |
|---|---|
| ReviewedSite | string - the name of the site reviewed |
| lastChangeTime | String (Timestamp format) - the last time |
| | that the site changed status |
| | A timestamp in RFC3339 UTC “Zulu” |
| | format accurate to nanoseconds. Example: |
| | “2014-10-02T15:01:23.045123456Z” |
| abusiveStatus | enum (AbusiveStatus) - the status of the site |
| | reviewed for the abusive experiences. |
| underReview | Boolean - whether the site is currently under |
| | review. |
| enforcementTime | String (TimeStamp format) - the date on |
| | which enforcement began. |
| | A timestamp in RFC3339 UTC “Zulu” |
| | format accurate to nanoseconds. Example: |
| | “2014-10-02T15:01:23.045123456Z” |
| reportURL | String - a link that leads to a full abusive |
| | experience report |
| filterStatus | enum(FilterStatus) - the abusive experience |
| | enforcement status of the site |

In some embodiments, the code may be software code written in various programming languages such as Python, Java, JavaScript, JSON, etc. An example of JSON code corresponding to the same information provided in Table 3 may be as follows:

{

“reviewedSite”: string,
“lastChangeTime”: string,
“abusiveStatus”: enum(AbusiveStatus),
“underReview”: boolean,
“enforcementTime”: string,
“reportURL”: string,
“filterStatus”: enum(FilterStatus)

}

In some embodiments, a “try out” may be an object that explains input parameters and output parameters of the selected API. Example extracted information from a “try out” may be as follows:

{

parameters: {

{

name: “name”,

description: “the required site name. This is the site property whose
abusive experiences have been reviewed and it must be URL encoded.

type: “string”

},
{

fields: “abusiveStatus, enforcementTime, filterStatus, lastChangeTime,
underReview, reporrtURL, reviewedSite
description: “Selector specifying which fields to include in a partial
response.”
}
}
}

After determining which type of API object is contained in the selected record, the extraction module 108 may thus extract information and/or content from the object. Data extraction may be enabled through any known data extraction method. From the data extracted from each object, the computing system 102 may then construct an OAS file, which may be machine-readable and used for further API specification purposes. In some embodiments, the computing system 102 may automatically create the OAS file from the information and/or content extracted during the parsing of the HTML files. The OAS file may be constructed in JSON or YAML, and may include general information about the API, available paths, available operations, input and output for each operation. In one example embodiment, creating the OAS file may include mapping each API object to an OAS format. For example, HTTP verb functions that are extracted from the HTML may be added to a JSON OAS file as follows:
ROOT->“paths”->“extracted endpoint”->“extracted HTTP verb.”

Furthermore, in some embodiments, the computing system 102 may use machine-learning to learn HTML tag constructions and content extraction in order to apply a set of rules to other API platforms and for other API providers in order to construct an OAS file. For example, in some embodiments, the computing system 102 may applying a natural language processing algorithm to each object and may employ machine-learning based classifications to improve HTML page parsing and data extraction. The natural language processing techniques may then be used to interact with various API providers and provided HTML pages in order to extract API information and content. In some embodiments, the machine learning algorithms may learn and predict DOM objects, as well as user actions for each API object. For example, the machine learning algorithms may learn a chain of actions (e.g., login, click on X) to extract one API object (e.g., endpoint).

The construction of an API specification using semi-structured information extraction may provide a number of benefits to the operation of a computer itself, and improvements to the related field of computer programming. With respect to the computer itself, the construction of the API specification may provide the computer with improved functionality by enabling a computing system to automatically interact with various HTML pages associated with an API provider in order to extract object information. In addition, the method and system described in this disclosure provides timely and more efficient computational time for machine learning tasks. Tasks may be allocated in order to take advantage of available resources which may also result in increased efficiency and communication time.

Furthermore, the present disclosure may permit a computing system to perform tasks not previously performable by computers. For example, the present disclosure may facilitate the correlation of attributes to functions from a plain language document describing an API resource such that computer-readable instructions for the API resource may be generated. Thus, embodiments of the present disclosure may improve the performance of a computer system itself.

With respect to improving computer programming, the present disclosure may provide enhanced capabilities and generation of computer-readable code. For example, the present disclosure may facilitate the generation of computer-readable code without needing manual interaction on an HTML page. Thus, embodiments of the present disclosure may improve the computer programming.

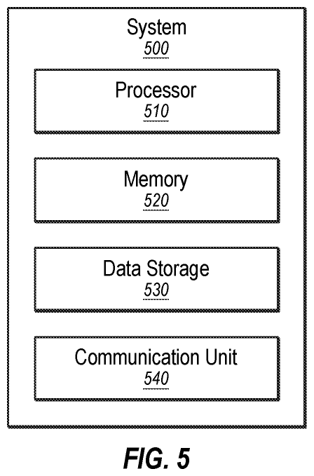

FIG. 5 illustrates an example computing system 500, according to at least one embodiment described in the present disclosure. The system 500 may include any suitable system, apparatus, or device configured to communicate over a network. The computing system 500 may include a processor 510, a memory 520, a data storage 530, and a communication unit 540, which all may be communicatively coupled. The data storage 530 may include various types of data, such as API documents, API specifications, etc.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to perform the methods 200, 300, or 400, of FIGS. 2, 3, and 4, respectively. For example, the processor 510 may obtain instructions regarding automatically and interactively extracting information from a provider's API platform, and applying a set of rules to a number of different APIs provided by the same API provider.

The memory 520 and the data storage 530 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510. In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 540 may permit data to be exchanged with a network and/or any other devices or systems described in the present disclosure. For example, the communication unit 540 may allow the system 500 to communicate with other systems, such as computing systems and/or other networks.

Modifications, additions, or omissions may be made to the system 500 without departing from the scope of the present disclosure. For example, the data storage 530 may be multiple different storage mediums located in multiple locations and accessed by the processor 510 through a network.

As indicated above, the embodiments described in the present disclosure may include the use of a special purpose or general purpose computer (e.g., the processor 510 of FIG. 5) including various computer hardware or software modules, as discussed in greater detail below. Further, as indicated above, embodiments described in the present disclosure may be implemented using computer-readable media (e.g., the memory 520 or data storage 530 of FIG. 5) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, or some other hardware) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A method, comprising:
accessing, by a processor, a first server associated with a first provider of at least one application programming interface (API);
automatically selecting, by the processor, the at least one API provided by the first provider;
constructing a list of features associated with the selected at least one API;
parsing, by the processor, a first HyperText Transfer Protocol (HTML) page associated with the selected at least one API;
automatically simulating, by the processor, at least one user interaction with the first HTML page;
extracting, by the processor, API object information based on: a) constructing the list of features, b) parsing the first HTML page, and c) automatically simulating the at least one user interaction with the first HTML page; and
constructing, by the processor, a machine-readable API specification based on the extracted API object information.

2. The method of claim 1, further comprising:
parsing, by the processor, a second HTML page associated with the selected at least one API;
automatically simulating, by the processor, at least one user interaction with the second HTML page;
extracting API object information based on parsing the second HTML page and automatically simulating the at least one user interaction with the second HTML page; and
wherein constructing the machine-readable API specification further comprises constructing the machine-readable API specification based on the parsing, the automatic simulating, and the extracting of the API object information.

3. The method of claim 1, wherein constructing the list of features further comprises:
constructing a list of features selected from the group of: HTML object information, Document Object Model (DOM) objects, Cascading Style Sheet (CCS) objects, HTML tags, or a combination thereof.

4. The method of claim 1, wherein extracting API object information further includes:
automatically extracting API object information further based on the constructed list of features and API object information values.

5. The method of claim 1, wherein automatically selecting further comprises:
determining, by the processor, a presence of an interactive object on a second HTML page associated with the API, the interactive object being a uniform resource locator (URL); and
automatically simulating interactions of a user with the URL to access information regarding the selected at least one API.

6. The method of claim 1, wherein automatically simulating user interactions on the first HTML page further comprises:
programmatically simulating at least one of scrolling, logging in, clicking on a link, clicking on a button, dragging-and-dropping, selecting, or a combination thereof.

7. The method of claim 1, wherein constructing the machine-readable API specification further comprises:
constructing an OpenAPI (OAS) Specification based on semi-structured extracted data.

8. The method of claim 7, wherein constructing the OAS specification further comprises:
constructing the OAS specification in JavaScript Object Notation (JSON) or YAML Ain′t Markup Language (YAML).

9. The method of claim 1, wherein accessing the first server further comprises:
accessing a semi-structured API platform.

10. The method of claim 1, further comprising:
training a machine-learning model to automatically construct the machine-readable API specification based on the extracted API object information.

11. A system, comprising:
a memory;
a processor operatively coupled to the memory, the processor configured to perform operations comprising:
accessing, by a processor, a first server associated with a first provider of at least one application programming interface (API);
automatically selecting, by the processor, the at least one API provided by the first provider;
constructing a list of features associated with the selected at least one API;
parsing, by the processor, a first HyperText Transfer Protocol (HTML) page associated with the selected at least one API;
automatically simulating, by the processor, at least one user interaction with the first HTML page;
extracting, by the processor, API object information based on: a) constructing the list of features, b) parsing the first HTML page, and c) automatically simulating the at least one user interaction with the first HTML page; and
constructing, by the processor, a machine-readable API specification based on the extracted API object information.

12. The system of claim 11, further comprising:
parsing, by the processor, a second HTML page associated with the selected at least one API;
automatically simulating, by the processor, at least one user interaction with the second HTML page;
extracting API object information based on parsing the second HTML page and automatically simulating the at least one user interaction with the second HTML page; and
wherein constructing the machine-readable API specification further comprises constructing the machine-readable API specification based on the API object information based on parsing the first HTML page and the second HTML page.

13. The system of claim 11, wherein constructing the list of features further comprises:
constructing a list of features selected from the group of: HTML object information, Document Object Model (DOM) objects, Cascading Style Sheet (CCS) objects, HTML tags, or a combination thereof.

14. The system of claim 11, wherein extracting API object information further includes:
automatically extracting API object information further based on the constructed list of features and API object information values.

15. The system of claim 11, wherein automatically selecting further comprises:
determining, by the processor, a presence of an interactive object on a second HTML page associated with the API, the interactive object being a uniform resource locator (URL); and
automatically simulating interactions of a user with the URL to access information regarding the selected at least one API.

16. The system of claim 11, wherein automatically simulating user interactions on the first HTML page further comprises:
programmatically simulating at least one of scrolling, logging in, clicking on a link, clicking on a button, dragging-and-dropping, selecting, or a combination thereof.

17. The system of claim 11, wherein constructing the machine-readable API specification further comprises:
constructing an OpenAPI (OAS) Specification based on semi-structured extracted data.

18. The system of claim 17, wherein constructing the OAS specification further comprises:
constructing the OAS specification in JavaScript Object Notation (JSON) or YAML Ain′t Markup Language (YAML).

19. The system of claim 11, wherein accessing the first server further comprises:
accessing a semi-structured API platform.

20. One or more non-transitory computer-readable media containing instructions which, when executed by one or more processors, cause a system to perform operations, the operations comprising:
accessing, by a processor, a first server associated with a first provider of at least one application programming interface (API);
automatically selecting, by the processor, the at least one API provided by the first provider;
constructing a list of features associated with the selected at least one API;
parsing, by the processor, a first HyperText Transfer Protocol (HTML) page associated with the selected at least one API;
automatically simulating, by the processor, at least one user interaction with the first HTML page;
extracting, by the processor, API object information based on: a) constructing the list of features, b) parsing the first HTML page, and c) automatically simulating the at least one user interaction with the first HTML page; and
constructing, by the processor, a machine-readable API specification based on the extracted API object information.
